(19) United States
(12) Patent Application Publication
(10) Pub. No.: US 2010/0176985 A1
(43) Pub. Date: Jul. 15, 2010

(54) Systems and methods of global positioning systems using wireless networks

(75) Inventor: Ranjan Sharma, New Albany, OH (US)

Correspondence Address: HARNESS, DICKEY & PIERCE, P.L.C., P.O. BOX 8910, RESTON, VA, 20195, US

(73) Assignee: LUCENT TECHNOLOGIES INC.

(21) Appl. No.: 12/318,942

(22) Filed: Jan. 13, 2009

(51) Int. Cl. G01S 1/00

(52) U.S. Cl. 342/357.1

(57) ABSTRACT

Example embodiments use wireless network signals containing geographic data in order to determine a location of a device receiving and/or processing the wireless network signals. For example, the wireless signals may be transmitted as part of a Wide-Area network or Wireless Local Access Network (WLAN) from a wireless access node, commonly present in private and commercial dwellings. Example embodiments and methods may utilize the geographic data in the wireless signals to quickly determine a location in areas and at times when conventional GPS signals are not available. Similarly, example methods and systems may use geographic data from wireless signals to supplement available conventional GPS data in order to more quickly and/or more accurately determine geographic information.

### BACKGROUND

1. Field

Example embodiments generally relate to systems and methods of satellite-based global positioning systems, wireless networks, and systems and methods using the same.

2. Description of Related Art

FIG. 1 is an illustration of a conventional Global Positioning System (GPS) 1. As shown in FIG. 1, a GPS-capable device/GPS user 10, receives signals 20 from one or more non-terrestrial satellites 15 in orbit about the earth. The conventional GPS device 10 may be, for example, a stand-alone GPS device, a mobile telephone, a commercial aircraft navigation system, and/or any other known GPS that receives and processes signals 20, which are conventionally transmitted at 1176.45 MHz from GPS satellites 15.

The GPS device 10 conventionally requires signals from multiple satellites 15 in order to successfully determine a longitudinal and latitudinal position through triangulation. Signals 20 may include satellite clock, orbit, and/or status information broadcast from satellites 15. These pieces of information in signals 20 are typically broadcast serially and repetitively from each satellite 15, such that a GPS device 10 must receive signals 20 in their entirety in order to receive all this information together. Signals 20 are typically transmitted at 50 bits per second and are 1500 bits in length in order to include the clock, orbit, and status information. Thus, in order to receive all information within signals 20 and to calculate an accurate latitudinal and longitudinal position therefrom, GPS device 10 must receive multiple signals 20 for at least 30 consecutive seconds each. Similarly, in the situation when a conventional GPS device 10 is turned on at a point in time other than at the beginning of a signal 20 transmission, which is likely, it must wait until the next serial transmission in order to begin gathering complete signal data in order to provide an initial location, potentially adding anther full 30 seconds to an initial location determination.

Determining an accurate position from signals 20 may be affected by several factors in conventional GPS System 1. For example, when GPS device 10 is acquiring updated position information, it must typically acquire and analyze three different GPS signals 20 in their entirety before being able to determine an updated accurate global position. Breaks or interference with any of the signals 20 may restart the process, since the complete information of each signal 20 must be received and the information in signals 20 is transmitted serially. Obstacles 30, which include opaque and reflective objects like buildings, overpasses, tunnels, trees, atmospheric phenomenon, etc., may block or otherwise disrupt signals 30. Particularly in urban and suburban environments, buildings 30 may block and reflect signals 20, such that redundant and/or erroneous signals are received by GPS device 10 in a known “multi-path effect.” Buildings and structures 30 may similarly cause dispersion of signal 20, leading to weaker/insufficient signals received by GPS device 10 in a known “Sagnac effect.” Further complications, even after the GPS device 10 has been activated for some time, may be caused by these obstacles 30 as the GPS device 10 attempts to update its position while moving. That is, movement of the GPS device 10 itself among obstacles 30 may further contribute to loss of signals 20 and multi-pathing.

There are some known methods of mitigating the above-described difficulties in accessing sufficient information for determining accurate global position. For example, GPS device 10 may contain additional information about satellites 15 that permits calculation of position with less than all data from signals 20. Further, advanced signal processing may permit GPS devices 10 to capture and store information from signals 20, such that even if the signal is not received in its entirety, only missing parts of signal 20 must be received in the next serial transmission, such that all data is eventually collected through several broken transmissions. Multi-path effects may be reduced by accounting for movement of GPS device 10, location of obstacles 30, and atmospheric conditions when analyzing signals 20. Additionally, GPS devices 10 may receive signals 20 from four or more satellites 15 in order to supplement location calculations if some signals 20 are bad or incomplete.

### SUMMARY

Example embodiments include systems and methods of Global Positioning Systems (GPS). Example embodiments use wireless networking signals containing geographic data in order to determine a location of a device receiving and/or processing the local wireless signals. The wireless signals may be transmitted as part of a wireless network, such as a Wide-Area Network and/or a Wireless Local Access Network (WLAN), for example, from a wireless access node, commonly present in private and commercial dwellings. Example embodiments and methods may utilize the geographic data in the wireless signals to quickly determine a location in areas and at times when conventional GPS signals are not available, including, for example, initial start-up of a GPS device, GPS signal obstruction, GPS signal dispersion, etc. Example methods also include determination of distances between example embodiment GPS devices and access nodes. Example methods and systems may use geographic data from wireless signals to supplement available conventional GPS data in order to more quickly and/or more accurately determine geographic information.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of a conventional Global Positioning System.

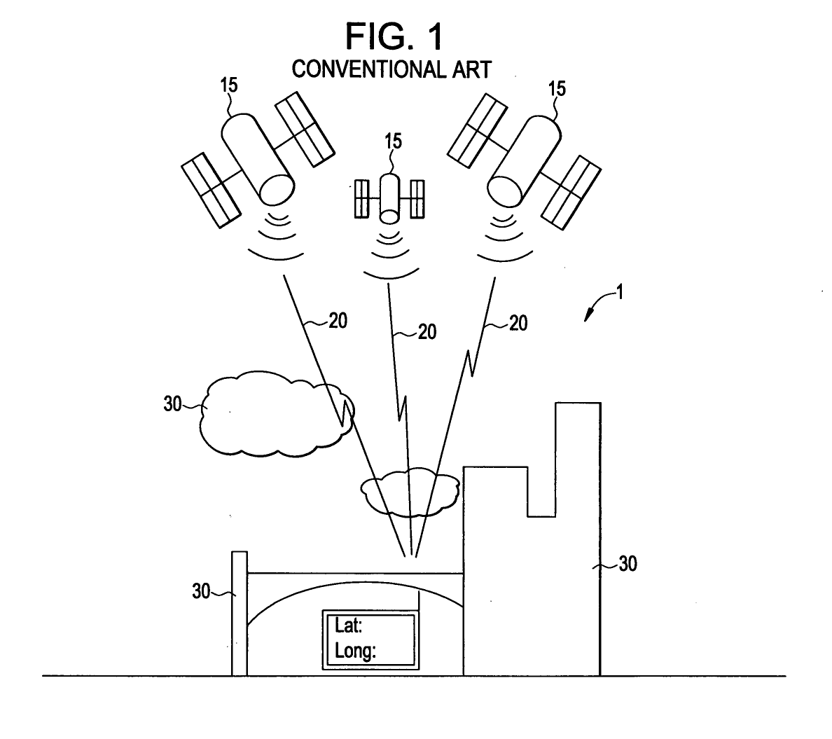

FIG. 2 is an illustration of an example embodiment Global Positioning System.

FIG. 3 is a flow chart describing an example method of operating a Global Positioning System

FIG. 4is an illustration of an example method of determining distances in a Wireless Local Access Network.

### DETAILED DESCRIPTION

Detailed illustrative embodiments of example embodiments are disclosed herein. However, specific structural and functional details disclosed herein are merely representative for purposes of describing example embodiments. The example embodiments may, however, be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

As used herein, the singular forms “a”, “an” and “the” are intended to include the plural forms as well, unless the language explicitly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially and concurrently or may sometimes be executed in the reverse order, depending upon the functionality/acts involved.

Although the figures and description use several terms and indicators to depict communicative connection between elements of example embodiments, it is understood that two distinct elements may be communicatively connected through wireless or physical media, including electromagnetic radiation and metallic cables, for example.

The inventor has recognized that the problems encountered by conventional Global Positioning Systems (GPS) and devices therein are not adequately addressed by conventional mitigation techniques. Particularly, the inventor has recognized that a lack of data from slow transmission speeds is not corrected by conventional GPS methods, which particularly complicates initial position determination following powering on GPS devices, when a complete data set must be newly acquired. The inventor has further recognized that known GPS methods do not adequately address the problems encountered with receiving GPS signals in urban and suburban environments with increased obstacles causing signal loss and a multi-path effect. Example embodiments and methods address and help mitigate these newly-recognized problems in a novel and unexpected manner.

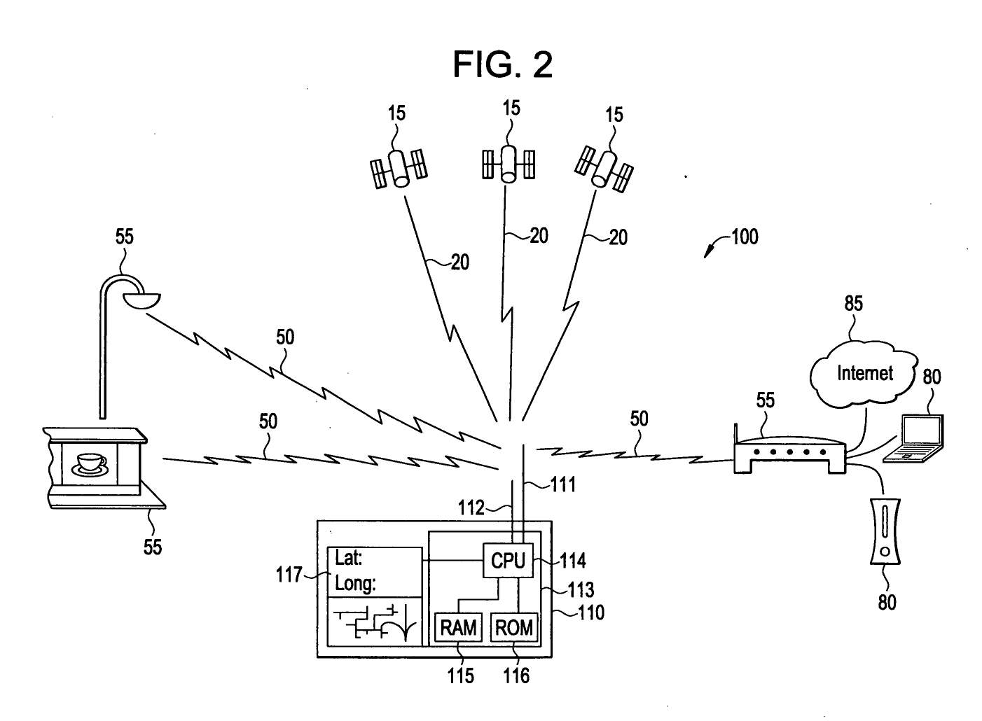

FIG. 2 is an illustration of an example embodiment GPS system 100 useable with example methods (discussed below) that may permit faster and/or more accurate position data gathering and position calculation. Example system 100 and methods thereof may be applicable following an initial powering on of an example embodiment GPS device 110 and/or during normal operation of GPS device 110. As shown in FIG. 2, an example embodiment GPS device 110 may receive and process conventional GPS signals 20 from orbiting satellites 15 through a GPS antenna 112. Unlike conventional GPS devices, however, example embodiments are configured to receive and process signals 50 from terrestrial wireless networks, alone or in addition to conventional GPS signals 20.

Terrestrial wireless signals 50 are conventionally transmitted at about 2.4 GHz from wireless access locations or nodes 55, in one of several known broadcast channels that may overlap within the 2.4 GHz band. Example embodiment GPS device 110 may include an additional antenna 111 or other receiving device and processor configured to receive and process signals 50. Alternatively, instead of distinct antennas 111 and 112, GPS device 110 may include a single antenna that is capable of receiving signals transmitted at multiple frequencies, including both conventional GPS signals 20 at about 1176.45 MHz and terrestrial wireless signals 50 at about 2.4 GHz. Antennas 111 and/or 112 may be connected to a receiver 113 configured to receive, process, and or analyze signals 20 and/or 50 in GPS device 110. Receiver 113 may include a processor 114, RAM 115, ROM 116 and/or other modules and hardware that permit receiver 113 to process signals from antennas, including functions and determinations like signal power ratio and strength detection, averaging operations, information extraction, basic mathematical functions, etc, and output results of these operations. Alternately, example embodiment GPS devices may be configured to output data to an external processor, which is configured to perform the signal processing. Example embodiment GPS devices may further include a display or printing mechanism 117 to output location and other information from receiver 113 and/or processor 114. Although receiver 113, processor 114, RAM 115, ROM 116, and presentation device 117 are shown in a single example embodiment GPS device 110, it is understood that any of these or other components may be remote from device 110 or missing altogether.

Wireless access nodes 55 may include a transmitter and/or receiver using terrestrial local wireless communication to exchange data between users and a data source, such as the Internet. Conventional wireless signals 50 may be transmitted from access nodes 55 at about 100 mW, corresponding to about −10 dBm power ratio for the signal 50 received in the immediate vicinity of the access node 55. Signals 50 may be received and processed at power ratios as low as −80 to −90 dBm or lower, permitting reception and processing of signals 50 at distances up to about 32 meters (approximately 100 feet) indoors or about 95 (approximately 300 feet) meters outdoors from access node 55, by example GPS device 110. Greater reception distances may be possible by boosting the power of access nodes 55 in example system 100. A network and wireless access nodes 55 may operate on any of several known standards and protocols, including WiFi, 802.11a, WiMax, etc. It is understood that a network accessed through such signals may be very limited, potentially limited to a single computer/processor broadcasting only geographic information with no other networking capabilities, or very extensively-networked to several distinct devices 80 and/or Internet/world wide web 85.

Wireless access nodes 55 are commonly present and detectable within public and private areas of urban and suburban environments, and are becoming increasingly present and detectable in these environments. For example, wireless access nodes 55 and connection to the Internet threrethrough may be publicly accessible through municipal and/or commercial operators. Some cities may offer free or fee-based public access nodes 55 located in city-owned structures or buildings, such as libraries, streetlights, etc., allowing residents to detect and access the Internet or other network devices through public wireless signals 50. Similarly, commercial establishments, such as coffee shops, airports, cafes, etc., may offer free or fee-based access nodes 55 (sometimes called hotspots) within their establishments to allow patrons to detect and access the Internet or other network through wireless signals 50. Or, for example, wireless access nodes 55 may be privately-owned for home or family access and networking, such as a commercial wireless router for home networking. Because these types of wireless access nodes 50 may be densest in urban and suburban areas, with higher population densities, higher commercial activity, and/or increased demand for wireless access, wireless signals 50 may be similarly densest in these areas.

Although wireless signals 50 may be transmitted from public or private access nodes 55, discussed above, any device having an appropriate antenna 111 and processing capability, including example embodiment GPS devices, may receive and process wireless signals 50 having sufficient signal strength. Although access to the Internet and/or other network resources via wireless signals may require authorization and authentication and/or use one or more encryption techniques, under several known wireless protocols, wireless signals 50 purposefully include publicly-accessible information for identifying the source of the signal 50 and communicating with the corresponding access node 55. For example, WiFi and IEE 802.11 standards commonly use a Service Set Identifier (SSID) as a field within signals 50 that publicly identifies the access node 55 transmitting the signal. An SSID may be advertised/transmitted in clear text without compromising the access point's and/or network security, as authorization and authentication may be required to access other network resources, as discussed above. The conventional SSID is a field of 32-octet length that may be continuously broadcast, or broadcast upon request if the SSID is already known, and may be receivable and decipherable to any WiFi-enabled device receiving a wireless signal 50 containing the SSID.

As shown in FIG. 2, in example embodiment system 100, GPS device 110 is communicatively connected to at least one access node 55 and receives and processes wireless signals 50 therefrom. GPS device 110 may further be receiving and processing conventional GPS signals 20; however, GPS signals 20 are not required in example embodiments and, in light of the problems experienced in receiving such signals in urban environments, discussed above, may not be available. Example GPS system 100 being described, methods of GPS communication using example systems are now discussed, with some reference being made to FIG. 2.

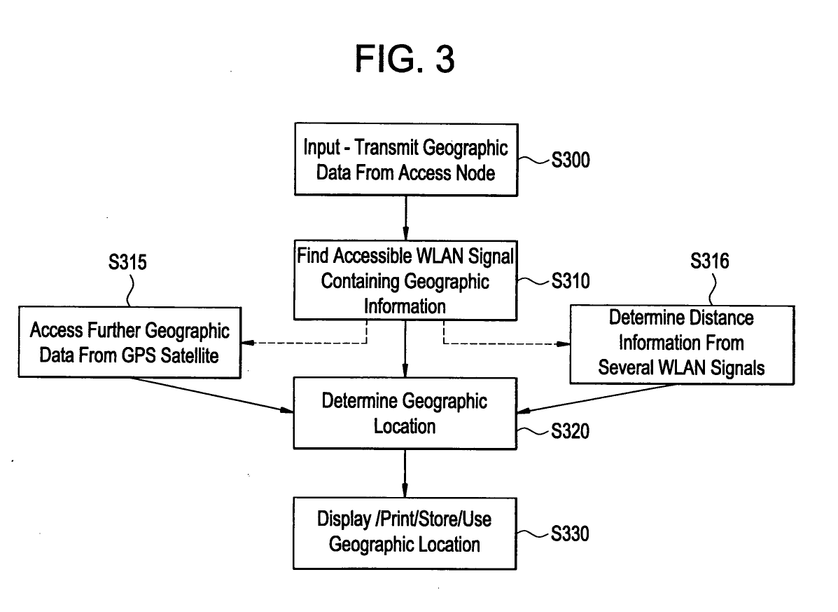

Example methods include using wireless signals 50 (FIG. 2) from available access nodes 55 alone in order to determine a global position or to supplement data received from other sources, such as conventional GPS signals 20, sent from GPS satellites 15. As shown in FIG. 3, example methods may include inputting and broadcasting geographic data from an access node 55 (FIG. 2). The geographic data describes the location of the transmitting access node in a recognizable format. For example, a latitude and longitude of the access node may be input into the access node and broadcast from the access node. The example latitude and longitude data may be input in conventional decimal and/or degrees/minutes/seconds formats. Other recognized position-related formats, with any desired level of precision, may equally be used in example methods and input into access nodes.

Operators and/or owners of the access nodes may manually enter the geographic data into the access node. For example, a user may input his or her street address into a known reverse geo-coding application on the Internet and input the resulting longitudinal and latitudinal coordinates into the access node. Alternatively, the access node may be automatically programmed to ascertain a coarse-resolution position and input the geographic data itself. For example, the access node may connect to a data source, such as the Internet, and determine its location through the data source, including a pre-programmed location data set, IP address indicating location, etc.

The access node broadcasts signals 50 (FIG. 2) including the geographic data describing its position in a format that can be freely received and processed by example embodiment GPS devices within the vicinity. In step S300, access nodes may broadcast continuously or in response to a specific request by an example GPS device, and access nodes may broadcast the geographic data in any part of its signals. As an example, the access node may operate under conventional WiFi protocol and may continuously transmit geographic data of its location in the SSID field. For a street address of 6100 East Broad Street, Columbus, Ohio, a latitude value of “39.979670” and longitude of “−82.839859” may be input into the SSID using at least 18 of the available 32 octets in WiFi SSID protocol. In the example, an additional 14 characters for periods, commas, negatives, separating fields, or access node status identifiers, including access node power level, may also be used, based on how the information is to be transmitted. Or, for example, a degrees/minutes/seconds format may be standardized and used where the SSID is formatted as:
SSID=[Access Node Power] [,] [Latitude][,][Longitude]
where
Access Node Power=3-digit number indicating power level of the access node, in mW
Latitude=[One letter for N or S] [2 digits for Degrees] [,] [2 digits for Minutes][,] [7 digits for Seconds, including a decimal]
Longitude=[One letter for E or W] [2 digits for Degrees] [,] [2 digits for Minutes] [,] [7 digits for Seconds, including a decimal]
   An example input using this format for the above address would thus be as “100N39,58,46.8000,W25,02,03.5000” that consumes all 32 octects of the SSID. Other formats may be used in example methods, as may alternate protocols and publicly-available fields transmitted in wireless signals. It is also understood that the users/operators/manufacturers executing step S300 may be distinct from (and wholly unknown to) the users of example GPS devices and further example steps and methods.

In step S310, an example embodiment GPS device surveys an applicable frequency for available wireless signals. Upon recognizing a signal, the GPS device may then analyze the signal in order to extract geographic data stored and publicly accessible therein. The recognition and extraction of data in step S310 may occur on the order of seconds or less, since wireless signals may be broadcast much more quickly than conventional GPS signals. Example embodiment GPS devices may recognize several different formats for geographic data and/or several different transmission protocols and data placement within the received wireless signals, as discussed above. Alternatively, a standardized transmission format, such as the degrees/minutes/seconds format discussed above, may be adopted by all users to further increase simplicity among example embodiments and potentially provide faster signal processing times. Upon receiving and identifying the wireless signal, the geographic data may be extracted from the signal by the GPS device or another independent processor. In accordance with above examples, an example GPS device may access the publicly-broadcast SSID in a WiFi signal and extract latitude and/or longitude information stored in the SSID. A single or several wireless signals containing geographic information may be detected and processed in step S310.

Once the geographic data in received wireless signals is identified and extracted, example GPS devices, or processing devices configured therewith, determine a geographic location based on this information in step S320. Multiple example methods of using the geographic data to determine a geographic location may be used; they are discussed in turn below, with the understanding that any of the discussed example methods may be used in combination.

For example, in step S320, a single wireless signal containing geographic data may be received and analyzed. An example embodiment GPS device may then calculate a position based on the single wireless signal alone and output, display, store, or otherwise use the calculated position. As discussed above, conventional wireless signals may be detected at a maximum range of about 95 meters (approximately 300 feet) outside from the transmitting access node. Thus, the position of the access node transmitted in the single wireless signal may be an accurate geographic position of the detecting GPS device, within approximately ±95 meters (and potentially even more accurate when indoors).

Alternatively, geographic data from a wireless signal may be used in conjunction with data received from conventional GPS signals 20 (FIG. 2) in step S315. For example, a GPS device may supplement data from GPS signals with the data from a wireless signal. Or, if GPS signals become temporarily unavailable or unreliable, the GPS device may instead use geographic data from a wireless signal to determine a coarse geographic location, determine if the GPS signals are erroneous, determine if the GPS device has moved, etc. In this way, the geographic location determined in step S320 may be based on both wireless signal(s) and GPS signal(s).

Further alternatively, geographic data from multiple wireless signals may be used together. For example, after extracting geographic data from multiple signals in step S310, example methods may combine the data in an averaging operation to determine a more accurate geographic location in step S320. Additionally, if distance information between the multiple access nodes transmitting the multiple wireless signals is known or determinable in step S316, a very precise position of an example embodiment GPS device may be calculated from wireless signals alone.

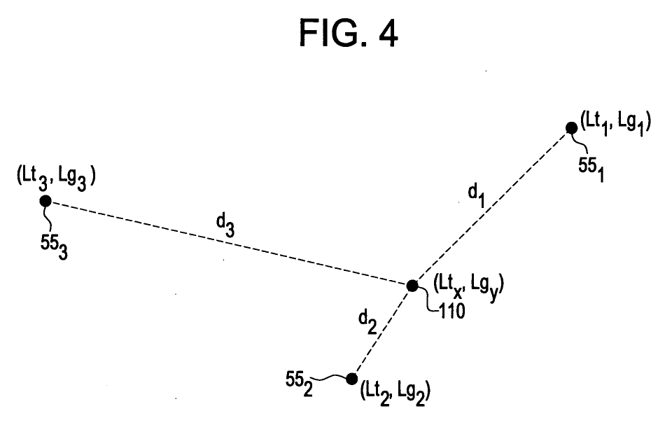

FIG. 4 illustrates an example method of determining position of multiple access nodes, such as the method employed in step S316 (FIG. 3), based on wireless signal characteristics. As shown in FIG. 4, an example embodiment GPS device 110 is in communications with three access nodes 55₁, 55₂, and 55₃. Each access node transmits a set of latitude and longitude giving its global position in accurate terms: access node 55₁ is at (Lt₁, Lg₁); access node 55₂ is at (Lt₂, Lg₂); and access node 55₃ is at (Lt₃, Lg₃). Assuming that each access node 55_{1, 2, and 3} and the GPS device 110 are roughly in the same plane (which should be true at relatively short distances and small altitude differences), the latitude Ltₓ and longitude Lg_{y} of the GPS device 110 can be expressed in terms of the distance d₁, d₂, and d₃ between each access node and the device 110 as such:

(Lt₁−Ltₓ)²+(Lg₁−Lg_{y})²=d₁² (1)

(Lt₂−Ltₓ)²+(Lg₂−Lg_{y})²=d₂² (2)

(Lt₃−Ltₓ)²+(Lg₃−Lg_{y})²=d₃² (3)

If the distances d₁, d₂, and d₃ can be obtained, then any two of the above equations may be solved for a position of the GPS device 10 with precision and accuracy equal to the precision and accuracy in the access nodes' geographical data and the determined values d. Example methods of determining d₁, d₂, and d₃ are now described.

The inventor has recognized that power ratio of a signal transmitted from a conventional access node operated in conventional power ranges varies in an approximately inverse linear manner with distance from the access node, with obstacles further reducing the power ratio of the signal across the obstacle. Particularly, for a conventional 100 mW access node, such as a standard available wireless router, signal strength deceases by approximately 10 dBm for every 6.1 meters (approximately 20 feet) from the access node, without significant obstacle interference.

If example embodiment GPS receivers 110 are configured to determine the power ratio of received wireless signals, then GPS receivers may calculate an accurate distance d between a current location of the GPS device and an access node, if the signal strength vs. distance relationship is known. This relationship may be the defaulted to the 10 dBm/6.1 meter relationship determined by the inventor. Alternatively, access nodes may be input with and transmit the relationship information along with the geographical information discussed above. For example, the excess digits in the SSID field may be filled with “1.64”—indicating the signal strength loss versus distance rate—and a maximum power, with which a distance may be calculated. Alternatively, other rates may be experimentally determined by access node operators and users may be input and transmitted, and other default values may be initially input by access node manufacturers. Similarly, other data, including access node transmit power, especially in the case that the access node power has been boosted beyond conventional levels as discussed above may be used as input and broadcast to permit a calculation of distance between example embodiment GPS devices and access nodes.

When at least two of the distances d₁, d₂, and d₃ in equations (1)-(3) above are determined in step S316 of FIG. 3 by way of the example methods, a geographic location set for the GPS device may be determined in step S320. Once the geographic location has been determined using one or more of the above example methods alone or in combination, the geographic location, including latitude and longitude may be printed, displayed, stored, and/or otherwise used on an example embodiment GPS device in step S330. For example, GPS devices may use the calculated geographic location to determine street address, zip code, time zone, etc., in conjunction with other correlating data.

Because example GPS methods and systems determine locations from wireless signals that are continuously broadcast and/or continuously available in urban and suburban areas, example GPS methods and systems may provide faster and/or more accurate acquisition of location data in urban or suburban areas, where conventional GPS signals are lost, corrupted, or otherwise unavailable. Similarly, because wireless signals and geographic data therein as described in example methods and systems may be quickly scanned and processed, an initial geographic location acquisition following startup or other loss of GPS signals may be more quickly achieved compared to conventional methods and devices using signals from GPS satellites. Further, because wireless signals may be densely present in areas with large populations, example GPS methods and systems may work in areas, such as building basements and/or when driving in tunnels, where conventional GPS signals cannot penetrate to conventional GPS devices.

Example embodiments and methods thus being described, it will be appreciated by one skilled in the art that example embodiments may be varied through routine experimentation and without further inventive activity. For example, although various example methods and devices have been described as determining location, it is understood and easily achieved to determine velocity and acceleration with example devices and methods. Variations are not to be regarded as departure from the spirit and scope of the exemplary embodiments, and all such modifications as would be obvious are intended to be included within the scope of the following claims.

1. A Global Positioning System (GPS) device, comprising:
a first antenna configured to receive a first signal transmitted from a wireless access node of a wireless network, the first signal including an access node power value for the wireless access node and geographic data of the access node; and
a processor configured to calculate a position of the GPS device based on the geographic data of the access node, the access node power value, and a signal strength of the first signal.

2. The GPS device of claim 1, further comprising:
a second antenna configured to receive at least one second signal transmitted from at least one associated non-terrestrial GPS satellite, the second signal including geographic data of the at least one GPS satellite, wherein the processor is configured to calculate a position of the GPS device based on at least one of the geographic data of the access node and the geographic data of the at least one GPS satellite.

3. The GPS device of claim 1, further comprising:
a presentation device configured to output the calculated position of the GPS device.

4. The GPS device of claim 1, wherein at least one of the first antenna and the processor are configured to determine a distance between the GPS device and the wireless access node based further on signal data included in the first signal.

5. The GPS device of claim 4, wherein the processor is configured to calculate the position of the GPS device based on the geographic data and the distance.

6. The GPS device of claim 1, wherein the first antenna is additionally configured to receive at least one second signal transmitted from at least one associated non-terrestrial GPS satellite, the second signal including geographic data of the at least one GPS satellite, and wherein the processor is configured to calculate a position of the GPS device based on at least one of the geographic data of the access node and the geographic data of the at least one GPS satellite.

7. The GPS device of claim 1, wherein the first antenna is configured to receive a plurality of first signals transmitted from a plurality of wireless access nodes, and wherein the processor is configured to calculate the position of the GPS device based on the geographic data in each of the plurality of signals.

8. The GPS device of claim 7, wherein the processor is configured to determine a distance between the GPS device and each of the wireless access nodes based on a strength of each of the first signals and data included in each of the first signals, and wherein the processor is configured to calculate the position of the GPS device based on the determined distances.

9. A Global Positioning System (GPS), comprising:
at least one terrestrial wireless access node providing wireless access to a network, the access node including geographic data of the access node and configured to transmit a first signal including the geographic data of the access node and an access node power value for the wireless access node in a Service Set Identifier of the first signal.

10. (canceled)

11. The GPS of claim 9, wherein the geographic data includes a latitude value of the wireless access node and a longitude value of the wireless access node.

12. The GPS of claim 9, wherein the access node is configured to at least one of,
be manually input with the geographic data of the access node by a user, and
automatically retrieve the geographic data of the access node from an outside data source.

13. The GPS of claim 12, wherein the outside data source is at least one of the Internet and a GPS device.

14. A method of obtaining a geographic location of a Global Positioning System (GPS) device, the method comprising:
receiving, at the GPS device, a first signal transmitted from a terrestrial wireless access node of a wireless network, the first signal including an access node power value for the wireless access node and geographic data of the access node; and
calculating the geographic location of the GPS device based on the geographic data of the access node, the access node power value, and a signal strength of the first signal.

15. The method of claim 14, further comprising:
receiving, at the GPS device, a second signal transmitted from an associated non-terrestrial GPS satellite, the second signal including geographic data of the GPS satellite; and
calculating the geographic location of the GPS device based on at least one of the geographic data of the access node and the geographic data of the GPS satellite.

16. The method of claim 14, further comprising:
determining a distance between the GPS device and the wireless access node based on at least one of a signal strength and signal data included in the first signal; and
determining the geographic location of the GPS device based on the geographic data and the distance.

17. The method of claim 16, wherein the first signal includes a plurality of first signals received from multiple access nodes, wherein the determining the geographic location of the GPS device includes calculating a plurality of distances between the antenna and each of the access nodes, and wherein the geographic location is determined based on the geographic data from the access nodes and the plurality of distances.

18. A method of operating a Global Positioning System (GPS), the method comprising:
transmitting a first signal from at least one terrestrial wireless access node providing wireless access to a network, the first signal including geographic data of the access node and an access node power value for the wireless access node in a Service Set Identifier of the first signal.

19. The method of claim 18, wherein the Service Set Identifier is publicly accessible, and wherein the geographic data includes a latitude value of the wireless access node and a longitude value of the wireless access node.

20. The method of claim 1, wherein the geographic data and the access node power value are included in a Service Set Identifier of the first signal.
